(19) United States
(12) Patent Application Publication
(10) Pub. No.: US 2010/0128374 A1
(43) Pub. Date: May 27, 2010

(54) Portable Mirror For Displaying An Unreversed Image

(76) Inventors: Lawrence C. Zaglin, Atlanta, GA (US); Larry Johnson, Woodstock, GA (US)

Correspondence Address: MORGAN, LEWIS & BOCKIUS, LLP. (PA), 2 PALO ALTO SQUARE, 3000 EL CAMINO REAL, SUITE 700, PALO ALTO, CA, 94306, US

(21) Appl. No.: 12/277,151

(22) Filed: Nov. 24, 2008

(51) Int. Cl. G02B 5/08

(52) U.S. Cl. 359/866; 359/860; 359/838

(57) ABSTRACT

A portable mirror apparatus is described. The apparatus comprises a first mirror portion having a first mirrored side and a second side, and a second mirror portion having a third mirrored side and a fourth side, configured to be coupled perpendicularly by an attachment mechanism to the first mirror portion. The first mirror portion and second mirror portion, when attached in the perpendicular arrangement, are configured to provide an unreversed image. A magnetic mirror is described also, and a method for manufacturing it.

### RELATED APPLICATIONS

This application is related to U.S. Pat. No. 4,539,102, filed on Feb. 11, 1985, and issued on Jan. 27, 1987, which is incorporated by reference herein in its entirety.

### TECHNICAL FIELD

The disclosed embodiments relate generally to mirrors, and in particular to portable cosmetic mirrors.

### BACKGROUND

When a person views himself or herself in a mirror, the image afforded is reversed in front-to-rear relation in a manner such that the right and left sides of the face of the viewer appear as the left and right sides of the face. This reversal of image usually does not cause any problem to the viewer, inasmuch as the viewer has grown up and become accustomed to the reversal of the image obtained by user when viewing himself or herself in a mirror.

However, when the viewer is attempting to apply makeup it is impossible for the user to view himself or herself as seen by others. Accordingly, a need exists for a mirror construction whereby the user of the mirror may view himself or herself as seen by others.

Furthermore, it is desirable that the mirror be portable, inexpensive, and simple and intuitive to use.

### SUMMARY

A portable mirror apparatus is described. The portable mirror apparatus comprises a first mirror portion having a first mirrored side and a second side, and a second mirror portion having a third mirrored side and a fourth side. The first and second mirror portions are configured to be coupled perpendicularly by an attachment mechanism to the first mirror portion, such that the first mirror portion and second mirror portion, when attached in the perpendicular arrangement, provide an unreversed image.

In some embodiments, the first mirrored side and the third mirrored side face each other. In some embodiments, the portable mirror apparatus is configured for one-handed use when applying makeup. One-handed operation means that a user can hold the open mirror in one hand and apply makeup with the other.

In some embodiments, the first mirror portion and second mirror portion each comprise an attachment mechanism, and the first mirror portion and second mirror portion are configurable to be attached in the perpendicular arrangement using the attachment mechanism.

In some embodiments, the first mirror portion and second mirror portion are further configurable to be attached in a planar reversing reflecting arrangement using the attachment mechanism. In some embodiments, the attachment mechanism comprises a first magnet coupled to the first mirror portion and a magnetic metal coupled to the second mirror portion. In some embodiments, the attachment mechanism comprises a first magnet coupled to the first mirror portion and a second magnet having a polarity opposite to the first magnet coupled to the second mirror portion. In some embodiments, the attachment mechanism comprises a tongue on the first mirror portion and a groove on the second mirror portion, wherein the tongue and groove are configurable to hold the first and second mirrors in a perpendicular arrangement. In some embodiments, the attachment mechanism comprises an insert on the first mirror portion and a hole on the second portion, wherein the insert and hole are configurable to hold the first and second mirrors in a perpendicular arrangement. In some embodiments, the attachment mechanism comprises a spring arrangement on the first mirror portion and a hinge arrangement on the second mirror portion, wherein the spring and hinge are configurable to hold the first and second mirrors in a perpendicular arrangement

In some embodiments, the portable mirror apparatus further comprises a latch mechanism coupled to the first mirror portion, wherein the latch mechanism is configurable to hold the first mirror portion and the second mirror portion together in a parallel overlapping arrangement. A parallel overlapping arrangement means that the mirrors may be stacked on top of each other. In some embodiments, the latch mechanism comprises a first latch magnet coupled to the first mirror portion, and a latch magnetic metal coupled to the second mirror portion. In some embodiments, the latch mechanism comprises a first latch magnet coupled to the first mirror portion, and a second latch magnet having a polarity opposite to the first latch magnet coupled to the second mirror portion.

In some embodiments, the portable mirror apparatus comprises a magnifying mirror coupled to the second side of the first mirror portion. In some embodiments, the portable mirror apparatus comprises a reducing mirror coupled to the second side of the second mirror portion. In some embodiments, the reducing mirror is shaped with a wider view along a long axis, and with a less wide view along a short axis.

In some embodiments, the first mirror portion and second mirror portion are further configured to be coupled by a second attachment mechanism in a parallel non-overlapping arrangement. In some embodiments, the parallel non-overlapping arrangement comprises having the first mirrored side and the second mirrored side in substantially the same plane, and facing substantially the same direction. ISE the second attachment mechanism comprises a third magnet coupled to the first mirror portion and a magnetic metal coupled to the second mirror portion.

In some embodiments, the second attachment mechanism comprises a third magnet coupled to the first mirror portion and a fourth magnet having a polarity opposite to the third magnet coupled to the second mirror portion.

A portable mirror apparatus is described. The portable mirror comprises a first mirror portion having a first mirrored side and a second side, and a second mirror portion having a third mirrored side and a fourth side. The first mirror portion and second mirror portion are configured to be coupled perpendicularly via one or more magnets to the first mirror portion such that the first mirrored side and the third mirrored side provide an unreversed image.

In some embodiments, the first mirrored side and the third mirrored side face each other. In some embodiments, the apparatus is configured for one-handed use when applying makeup.

In some embodiments, the first mirror portion and second mirror portion are further configurable to be attached in a planar reversing reflecting arrangement using the one or more magnets.

In some embodiments, the portable mirror apparatus comprises a first magnet coupled to the first mirror portion and a magnetic metal coupled to the second mirror portion. In some embodiments, the portable mirror apparatus comprises a first magnet coupled to the first mirror portion and a second magnet having a polarity opposite to the first magnet coupled to the second mirror portion.

In some embodiments, the portable mirror apparatus comprises a latch mechanism coupled to the first mirror portion, wherein the latch mechanism is configurable to hold the first mirror portion and the second mirror portion together in a parallel overlapping arrangement. In some embodiments, the latch mechanism comprises a first latch magnet coupled to the first mirror portion, and a latch magnetic metal coupled to the second mirror portion. In some embodiments, the latch mechanism comprises a first latch magnet coupled to the first mirror portion, and a second latch magnet having a polarity opposite to the first latch magnet coupled to the second mirror portion.

A method of manufacturing a portable magnetic mirror apparatus is described. A first mirror portion and a second mirror portion are formed, the first and second mirror portions having front surface mirrors. A plurality of holes are formed in each of the first and second mirrored portions. In some embodiments, a hole is a cavity that does not fully pass through the mirrored portion. A respective magnet of a plurality of magnets is coupled to a respective hole of the plurality of holes in each of the mirrored portions. The first and second mirrored portions are configurable to be magnetically attached in a perpendicular arrangement to provide an unreversed image.

In some embodiments, the first and second mirrored portions are further configurable to be magnetically attached in a flat arrangement to provide a reversed image. In some embodiments, the first and second mirrored portions are further configurable to be magnetically attached in an overlapping arrangement for storage.

A computer readable storage medium stores one or more programs configured for execution by a computer. The one or more programs comprise instructions to form a first mirror portion and a second mirror portion, the first and second mirror portions having front surface mirrors, to form a plurality of holes in each of the first and second mirrored portions, and to couple a respective magnet of a plurality of magnets to a respective hole of the plurality of holes in each of the mirrored portions. The first and second mirrored portions are configurable to be magnetically attached in a perpendicular arrangement to provide an unreversed image.

A method of displaying a mirror for sale includes displaying a mirror in a perpendicular configuration, wherein the mirror includes a first mirror portion having a first mirrored side and a second side and a second mirror portion having a third mirrored side and a fourth side, and displaying for sale a mirror in a parallel configuration. In the perpendicular configuration the first mirror portion and second mirror portion are coupled perpendicularly together such that the first mirrored side and the third mirrored side provide an unreversing reflector. In the parallel configuration the first mirror portion and second mirror portion provide a reversing reflector.

### BRIEF DESCRIPTION OF THE DRAWINGS

FIG. 1 illustrates a multi-part mirror showing first and second portions separated from each other, according to some embodiments.

FIG. 2 illustrates a back view of a multi-part mirror, where the first and second parts are coupled together forming a perpendicular mirror, according to some embodiments.

FIG. 3 illustrates a front view of a multi-part mirror, where the first and second parts are coupled together forming a perpendicular mirror, according to some embodiments.

FIG. 4 illustrates a front view of a multi-part mirror, where the first and second parts are coupled together forming a flat reversing mirror, according to some embodiments.

FIG. 5 illustrates a front view of a multi-part mirror, where the first and second parts are coupled together forming a non-reversing perpendicular mirror, according to some embodiments.

FIG. 6 illustrates a plurality of interlocking mechanisms for coupling first and second parts of a mirror together to form a non-reversing perpendicular mirror, according to some embodiments.

FIG. 7A-7C illustrates a plurality of interlocking mechanisms for coupling first and second parts of a mirror together to form a reversing flat mirror, according to some embodiments.

FIG. 8 illustrates a concave reversing mirror coupled to a back of a multi-part mirror, according to some embodiments.

FIG. 9 illustrates a convex reversing mirror coupled to a back of a multi-part mirror, according to some embodiments.

FIG. 10 illustrates a front view of a multi-part mirror, where the first and second parts are coupled together forming a T-shaped mirror viewing, according to some embodiments.

FIG. 11 illustrates a front view of a multi-part mirror, where the first and second parts are coupled together forming a free standing mirror having one reflective side facing towards a user, according to some embodiments.

FIG. 12 illustrates a flow diagram of a method of manufacturing a mirror configurable as an unreversing mirror, according to some embodiments.

FIG. 13 illustrates a flow diagram of a method of displaying for sale a mirror configurable as an unreversing mirror, according to some embodiments.

FIG. 14 illustrates a diagram of a manufacturing system.

FIG. 15 illustrates an exemplary two-part mirror constructed from double acrylic.

FIG. 16 illustrates an exemplary two-part mirror constructed from double acrylic.

FIG. 17 illustrates an exemplary two-part mirror constructed from double acrylic, having interlocking slots.

FIG. 18 illustrates an exemplary two-part mirror constructed from double acrylic, having interlocking slots.

FIG. 19 illustrates an exemplary two-part mirror constructed from double acrylic, having mounting slots at a plurality of angles

FIG. 20 illustrates an exemplary two-part mirror constructed from double acrylic, having mounting a bar magnet and a magnetic strip.

FIG. 21 illustrates an exemplary compact mirror having a normal mirror on an interior side and a hinged non-reversing mirror on an exterior surface.

Like reference numerals refer to corresponding parts throughout the drawings.

### DESCRIPTION OF EMBODIMENTS

A portable mirror apparatus is described. This mirror provides (amongst other features) an unreversed image of the user. In the following discussion, the user will be referred to as ‘her’, but it is to be understood that the discussion applies to all users, regardless of gender. This unreversed image allows a user to see herself as others perceive her, without the left-to right reversal that normally occurs in a mirror. This allows the user to see a truer representation (e.g., a natural view or a true view) of herself, and to see herself the same way that others do.

When the user applies cosmetics, makeup, accessories, shoes, or clothes she may check her appearance to verify that it is satisfactory. The user may wish to check just her face, or may wish to check her overall appearance from head to toe, or anything in between. The user may wish to have a close up view of a particular area (e.g. when applying eye make-up), or may wish a more distant view to see her whole appearance or ‘look’.

Conventional mirrors create a horizontally reversed image, i.e., the image perceived by a user of a conventional mirror is flipped left to right. While in some circumstances this reversal is just a minor inconvenience, where a user is creating a particular look (e.g., an asymmetrical look) or where the user wants to see herself as others perceive her, the conventional mirror may provide unsatisfactory results, requiring that the user mentally transpose the image (e.g., from left to right) to imagine how others would see her.

It is further desirable to have a portable unreversing mirror that a user can carry in a purse, handbag, or pocket. Such a portable unreversing mirror is preferably light, inexpensive, easy to use, and when stored does not take up significantly more space than a conventional mirror. The portable unreversing mirror is preferably suitable for use with one hand or with no hands. In some embodiments, the unreversing mirror is preferably suitable for use on a desk, on a countertop, on a shelf, when attached to a vertical surface or when held in a hand. In some embodiments, the unreversing mirror may be magnetically attached to the vertical surface (e.g., a wall, a door, a refrigerator, a file cabinet, a locker, etc.),

The portable mirror comprises a first portion and a second portion, where the first portion and second portion are distinct (i.e., not attached to each other by a cable, hinge, or other tangible means) and may be carried in a closed position. In some embodiments, in the closed position the first portion and second portion are overlapping (e.g., the mirrored surfaces are next to each other). When a user wants to use the mirror as an unreversing mirror, she takes the first portion and second portion and attaches them together in a perpendicular arrangement. This forms a reversing mirror, as the mirrored side 122 of the first portion and the mirrored side 142 of the second portion form a substantially ninety degree angle, thus providing an unreversed image.

In some embodiments, the user may attach the first portion and second portion together end to end, forming a flat plane (e.g., a long rectangle), and thus providing a longer or taller mirror than the first portion or second portion individually. In some embodiments, the user may attach the first portion and second portion together end to side, forming a flat plane, and thus providing a T-shaped mirror. The T-shaped mirror may be useful for a ‘head and shoulders’ view of the user, allowing her to see her hair, makeup, accessories, and jewelry all together in one view.

In some embodiments, the mirrors are cut by laser from one or more sheets of material. Laser cutting is a technology that uses a laser to cut materials, and is typically used for industrial manufacturing applications. Laser cutting works by directing the output of a high power laser, by computer (e.g. controlled by a computer using CAD instructions stored on a computer readable storage medium), at the material to be cut. The material then either melts, burns, vaporizes away, or is blown away by a jet of gas, leaving an edge with a high quality surface finish. Industrial laser cutters are used to cut flat-sheet material as well as structural and piping materials. A reflecting surface may be applied to surfaces of the mirror. In some embodiments, the mirrors are cut by a saw or blade. In some embodiments, the mirrors are cut by a water jet. In some embodiments, the mirrors are cut by melting with a hot wire. In some embodiments, the mirrors are cut by melting with a hot gas or plasma jet.

In some embodiments, the mirror is a front surface mirror, which prevents ‘ghost images’ that appear in regular back surface mirrors. Ghost images are caused by dual reflections off the mirrored surface and off the front glass surface in a regular (back surface) mirror. The use of front surface mirror (also known as first surface mirror) solves these problems. A front surface mirror is made by vacuum depositing an aluminum coating onto the front surface of glass or acrylic or some other substrate.

In another embodiment, the mirror, including the first portion and the second portion may be manufactured from injection-molded plastic, acrylic, or any other material that flows upon application of heat. In some embodiments, one or more thermoplastic materials such as polystyrene, ABS or acrylonitrile butadiene styrene, polyamide, polypropylene, polyethylene, polyvinyl chloride or PVC may be used to form the mirror.

The molten thermoplastic material is injected at high pressure into a mold, which is the inverse of the product's shape. The mold for the mirror may be made by a moldmaker (or toolmaker) from metal, usually either steel or aluminum, and precision-machined to form the features of the mirror portions. In some embodiments, the mold for the mirror may be made from a ceramic material. The moldmaker may use an electronic computer-aided design (CAD design) stored on a computer readable storage medium (e.g., a floppy disk, a compact disk, a digital video disk, a memory stick, a non-volatile memory device, a computer memory such as SRAM or DRAM memory, a hard drive, an online file repository, etc.) for the production of the mold. A reflecting surface may be applied to surfaces of the mirror after it is molded, for example a front-surface mirror as described.

In some embodiments, the mirror portions are drilled to create a cavity for installation of magnets. In some embodiments, the cavities are formed during the molding or cutting process.

In some embodiments, after the mirror portions have been created by cutting or by molding, magnets are installed/coupled to the mirror. The magnets may be installed by a manufacturer of the mirror portions, or may be installed by an assembler of the mirrors. In some embodiments, the magnets are a press fit into the mirror. In some embodiments, the magnets are glued into the mirror. In some embodiments, the magnets are crimped into the mirror. In some embodiments, the magnets are sold with the mirror portions and installed by an end user. In some embodiments, the magnets are molded directly inside the mirror during a molding process. In some embodiments, the magnets are molded directly inside sheets of material from which the mirror is cut. In some embodiments, a magnetic frame is applied to at least a portion of the mirror.

In some embodiments, the mirror itself is formed from a sheet of magnetic material, e.g., from stainless steel or any other material that has magnetic properties. In some embodiments, the stainless steel is polished to provide a mirror finish, and at least a portion of the stainless steel is magnetized. In some embodiments, a magnet (e.g., a rare earth magnet) is coupled to the stainless steel mirror. In some embodiments, two such stainless steel mirrors may be magnetically coupled to form a perpendicular mirror, or coupled together flat for storage. In some embodiments, a 400 grade or higher stainless steel metal is used for the mirrors, having ferritic and martensitic chromium alloys. In some embodiments, a 410 or higher grade stainless steel is used. In some embodiments, a 420, 430 or 440 grade steel is used, having high polishability and hardness.

In some embodiments, the mirror may be packaged for sale in a flat (non-perpendicular) configuration. In some embodiments, a sample of the unreversing mirror may be presented to potential purchasers and users (e.g., in a beauty store, a drugstore, a convenience store, a make-up counter at a department store, an online web-page store presence, etc.) by displaying a mirror or a representation of the mirror in a perpendicular configuration. It may be desirable to display the mirror in the perpendicular configuration so a potential purchaser can see the mirror first hand, pick up and hold the mirror for applying make-up, etc. It may be desirable to display the mirror in the parallel (long rectangle, attached end to end) configuration so a potential purchaser can see the different configurations the mirror may be used in, pick it up and manipulate or reconfigure it, etc. In some embodiments, a video or demonstration image and/or pamphlet about the mirror may be displayed at the point of sale to educate users about how the mirror can be used and/or configured in different ways.

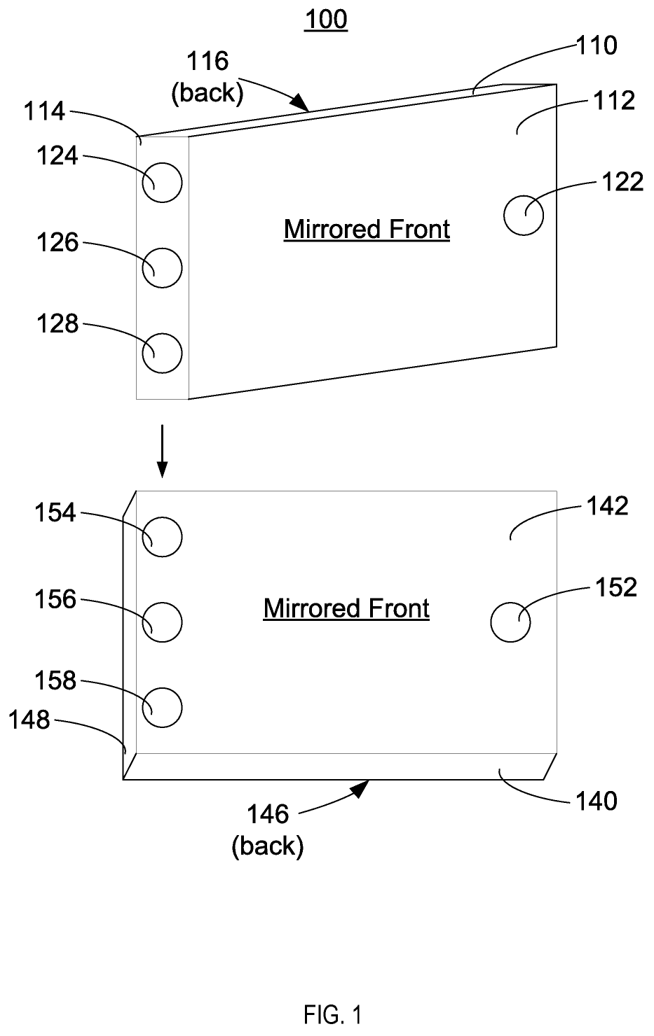

FIG. 1 illustrates a multi-part mirror having a first portion 101 and a second portion 102. The first portion 101 comprises a first mirrored side (mirrored front) 112, and a back 116. In some embodiments, the back 116 is not mirrored. In some embodiments, the first mirror 101 is rectangular or square in shape and has a long side 110 and a short side 114. In some embodiments, the mirror can have any shape, including triangular, semicircular, oval, or any other multi-sided shape. The short side 114 has one or more attachments (i.e., forming an attachment mechanism) 124, 126, 128 coupled to it. In some embodiments, the first mirrored side 112 has a latch (i.e., forming a latch mechanism) 122 coupled to it or proximate to it. In some embodiments, there may be one or more attachments on a long side 110 of the first mirror portion 101. An advantage of the magnetic latches over conventional ‘clasp’ latches is that there is nothing to catch on items inside a purse. In some embodiments, magnets of any size or shape can be used, including bar magnets, rectangular magnets, etc.

In some embodiments, the one or more attachments 124, 126, 128 and/or the latch 122 may comprise one or more magnets, including individual magnets, a bar magnet running along a length of the short side, or other configurations of magnets. In some embodiments, the one or more attachments may comprise one or more magnetic materials (e.g., ferrous material such as iron, steel, cobalt, nickel, or any material or object that produces a magnetic field). In some embodiments, the magnets are electromagnets. In some embodiments, the magnets are rare earth metals (e.g., gadolinium or dysprosium). In some embodiments, the magnets include one or more of ceramic or ferrite magnets, alnico magnets, ticonal magnets, injection molded magnets, or flexible magnets.

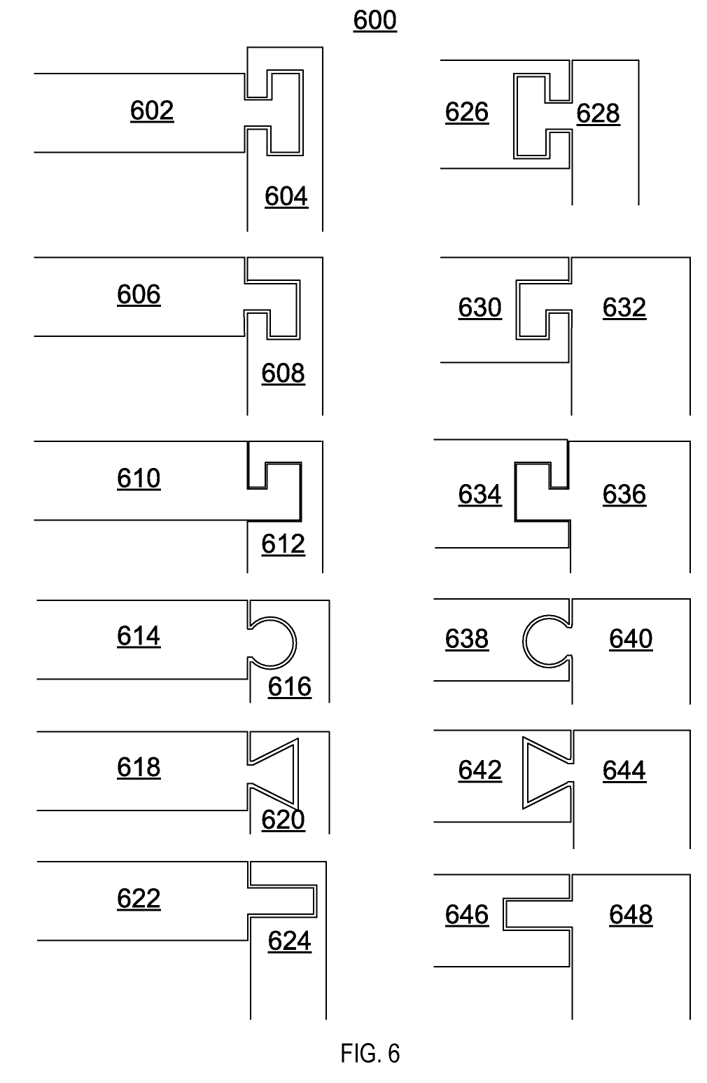

In some embodiments, the one or more attachment mechanisms 124, 126, 128 may comprise a mechanical interconnect, as described with reference to FIG. 6. In some embodiments, the attachment mechanisms may comprise a combination of magnetic and mechanical interconnect.

The second portion 102 of the multi-part mirror comprises a second mirrored side (mirrored front) 142 and a back 146. In some embodiments, the back 146 is not mirrored. In some embodiments, the second portion 102 is rectangular or square in shape (matching the first portion in size and shape) and has a long side 140 and a short side 148. The second mirrored side 142 has one or more attachments 154, 156, 158 coupled to it, near to the short side. In some embodiments, the second mirrored side 422 has a latch 152 coupled to it. In some embodiments, there may be one or more attachments on a long side 140 of the second mirror portion 102.

In some embodiments, the one or more attachments 154, 156, 158 are designed to compliment and attach to the attachments 124, 126, 128 respectively, and to support and maintain the first portion and the second portion in a perpendicular (ninety degree) position. In some embodiments, the one or more attachments 154, 156, 158 are magnetic. In some embodiments, the one or more attachments 154, 156, 158 comprise a mechanical interconnect. In some embodiments, the one or more attachments 154, 156, 158 may comprise a combination of magnetic and mechanical interconnect.

In some embodiments, the latches 122 and 152 are designed to compliment and attach to the each other, and to maintain the first portion and the second portion in a closed (overlapping) position. In some embodiments, when in the closed position, the one or more attachments 154, 156, 158 are magnetically attracted to attachments 128, 126, 124 respectively and assist in keeping the first portion and second portion in the closed position.

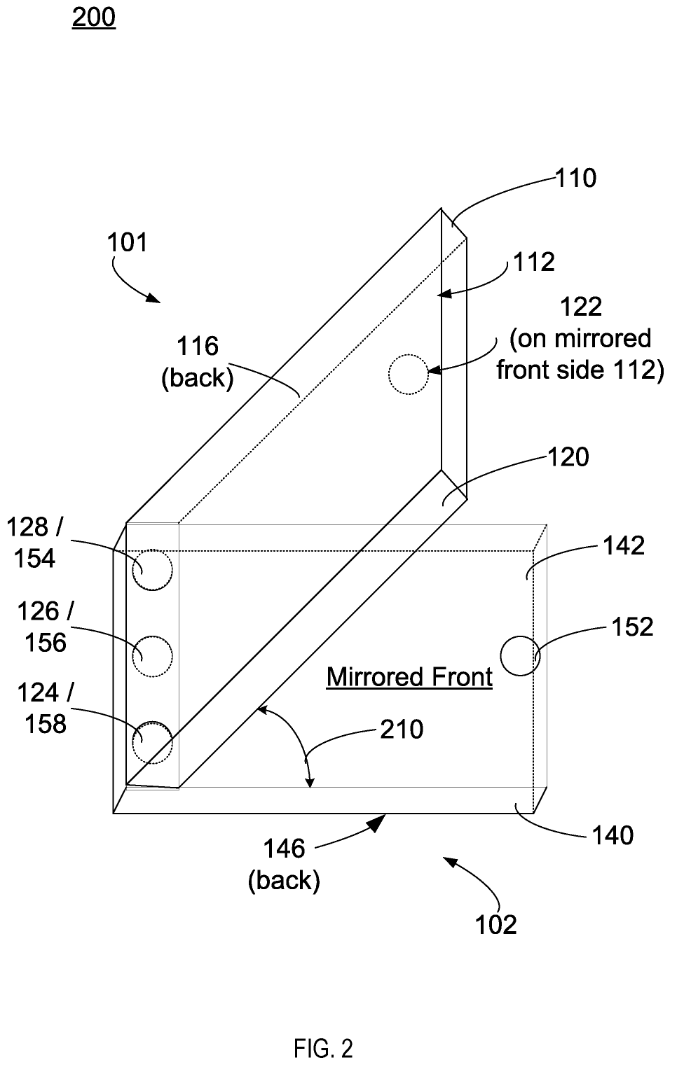

FIG. 2 illustrates a back view of an assembled multi-part mirror, where the first and second parts are coupled together forming a perpendicular mirror.

The first portion 101 is coupled to the second portion 102, with the one or more attachments coupled together (e.g., 128 to 154, 126 to 156, and 158 to 124) respectively. The first portion 101 and second portion 102 form a substantially ninety degree angle 210. The first mirrored side 112 and third mirrored side 142 form an unreversing mirror.

In one orientation, the assembled mirror may be stood/placed on a back side 146 of the second portion, where the back side 146 stands on a flat surface, e.g. a table, a shelf, etc. In another orientation, the assembled mirror may be placed on a long side 140 of the second mirror portion and a corresponding long side 120 of the first mirror portion, displaying an unreversing mirror. In another orientation, the first portion may be reversed 180 degrees relative to the second portion (with the attachments coupled 128 to 158, 126 to 156, and 124 to 154) so the first mirrored side faces away from the third mirrored side, thus displaying a reversing mirror supported at a 90 degree angle for placing on a shelf, etc. In another orientation, the first portion may be reversed so the first mirrored side faces away from the third mirrored side, and the mirror stood on a flat surface supported by the two uncoupled ends (e.g., the ends closest to the latches 122 and 152), thus displaying a reversing mirror at a 45 degree angle to a tabletop, etc.

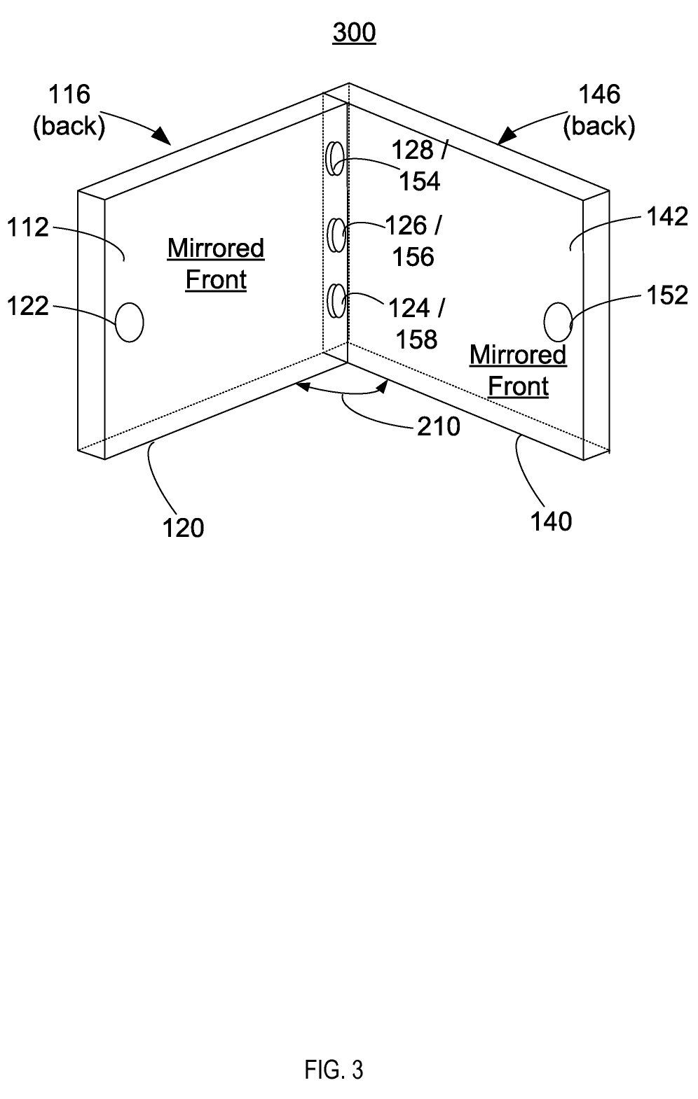

FIG. 3 illustrates a front view of a multi-part mirror, where the first and second parts are coupled together forming a perpendicular mirror. FIG. 3 shows the mirror of FIG. 1, turned to sit on long sides 120 and 140 of the first and second parts respectively.

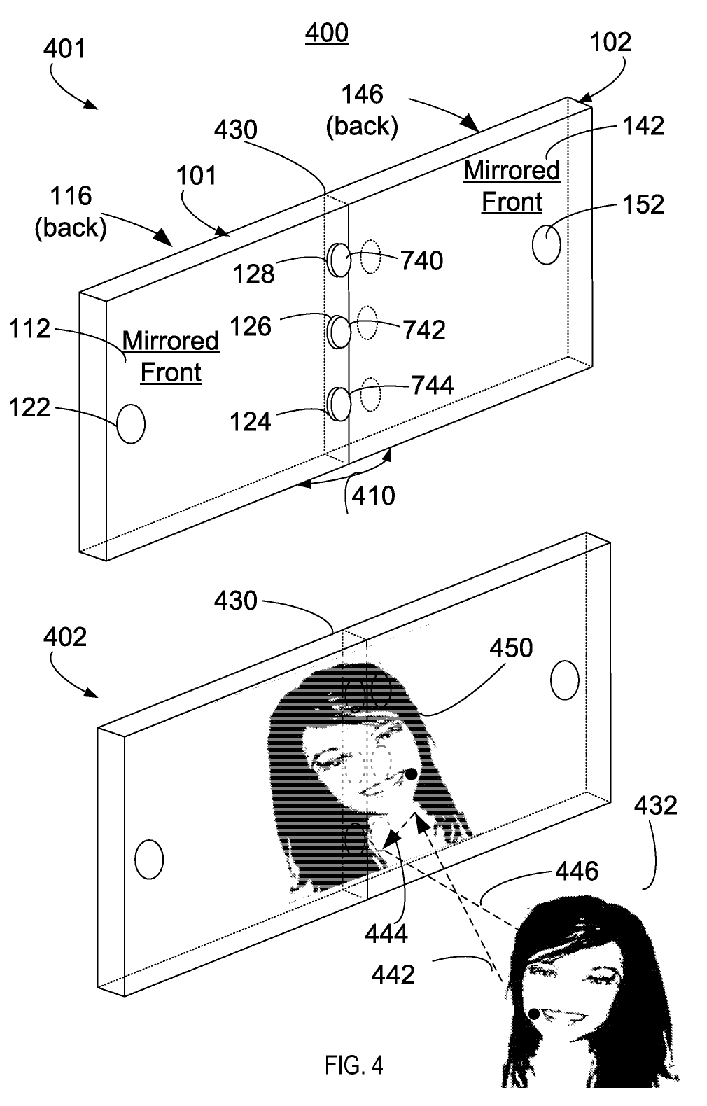

FIG. 4 illustrates a front view 401 of a multi-part mirror 430, where the first portion 101 and second portion 102 are coupled together forming a substantially parallel arrangement. This parallel arrangement forms a planar reversing mirror arrangement, i.e., a long (relative to the individual first and second mirror portions) flat reversing mirror. This long flat mirror may be useful for checking a user's ‘head to toe’ look. In some embodiments, mirrored front 122 of the first portion and mirrored front 142 of the second portion face in substantially the same direction, making an approximately planar tall mirror.

In some embodiments, mirrored front 112 of the first portion and mirrored front 142 of the second portion are coupled together with an angle between the mirrored fronts greater than 180 degrees, so the user gets a better view from head to toe without having to tilt the mirror up or down. For example, the first portion could show from waist to head, and the second portion could show from waist to feet, depending on the angle between the mirrored front 142 and mirrored front 112, and on how the combined mirror is held by a user.

In some embodiments, the second portion 102 has an attachment mechanism (e.g., attachments 740, 742, 744) on or near a side proximate to the attachments 128, 126, 124 respectively of the first portion. In some embodiments, attachments 740, 742, 744 are magnetic. In some embodiments, the magnetic attachments 740, 742, 744 are the same magnets used for attachments 158, 156, 154 respectively. In some embodiments, the attachments 740, 742, 744 are a single magnet. In some embodiments, the attachments 124, 126, 128 are a single magnet.

FIG. 4 further illustrates a front view 402 of a user 432 looking at the substantially parallel multi-part mirror 430. The user's face has a birthmark on her right side. When other people look at the user, they perceive the birthmark on the left side (relative to them) of the user. When the user looks in the mirror her image is reflected (442, 444, 446) back to her and is reversed horizontally. Thus, the user perceives in the mirror a reversed image 450 of herself with the birthmark on the opposite side.

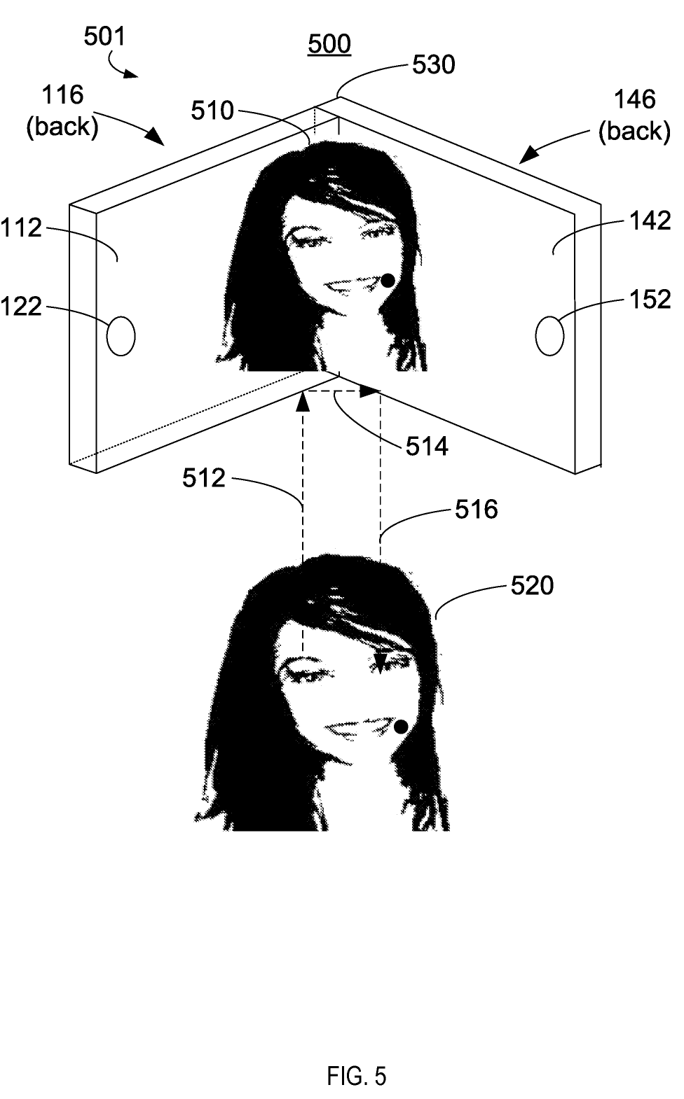

FIG. 5 illustrates a front view 501 of a multi-part unreversing mirror 530, where the first portion 101 and second portion 102 are coupled together with reflecting surfaces 112 and 142 forming a substantially perpendicular arrangement. This perpendicular arrangement forms an unreversing mirror, allowing a user to perceive herself as others perceive her.

The user's face 520 has a birthmark on her left side. When other people look at the user, they perceive the birthmark on the right side (relative to them) of the user. When the user looks in the unreversing mirror 530 her image is reflected from the first mirror portion to the second mirror portion (path 512, 514) and then back (path 516) to her and appears unreversed. Thus, the user perceives in the mirror 530 an unreversed image 510 of herself with the birthmark on the right side, the same as others perceive her.

FIG. 6 illustrates a plurality of interlocking mechanisms for coupling first and second parts of a mirror together to form a non-reversing perpendicular mirror, according to some embodiments.

In some embodiments, a first portion 602 has a T-shaped tongue 603 extending in line with the plane of the first portion. The tongue 603 may be coupled to a corresponding T-shaped groove in second portion 604, where the groove is configured to receive the tongue 603 when the first portion is perpendicular to the second portion.

In some embodiments, a second portion 628 has a T-shaped tongue 627 extending perpendicular to the plane of the second portion. The tongue 627 may be coupled to a corresponding T-shaped groove in first portion 626, where the groove is configured to receive the tongue 627 when the first portion is perpendicular to the second portion.

In some embodiments, a first portion 606 has an L-shaped tongue 607 that may be coupled to a corresponding L-shaped groove in second portion 608, as described. In some embodiments, a first portion 630 has an L-shaped groove that may be coupled to a corresponding L-shaped tongue 631 of second portion 632.

In some embodiments, a first portion 610 has a reverse L-shaped tongue 611 that may be coupled to a corresponding reverse L-shaped groove in second portion 612, as described. In some embodiments, a first portion 634 has a reverse L-shaped groove that may be coupled to a corresponding reverse L-shaped tongue 635 of second portion 636.

In some embodiments, a first portion 614 has a ball-shaped tongue 615 that may be coupled to a corresponding ball-shaped groove in second portion 616, as described. In some embodiments, a first portion 638 has a ball-shaped groove that may be coupled to a corresponding ball-shaped tongue 639 of second portion 640.

In some embodiments, a first portion 618 has a dovetail-shaped tongue 619 that may be coupled to a corresponding dovetail-shaped groove in second portion 620, as described. In some embodiments, a first portion 642 has a dovetail-shaped groove that may be coupled to a corresponding dovetail-shaped tongue 643 of second portion 644.

In some embodiments, a first portion 618 has a dovetail-shaped tongue 619 that may be coupled to a corresponding dovetail-shaped groove in second portion 620, as described. In some embodiments, a first portion 642 has a dovetail-shaped groove that may be coupled to a corresponding dovetail-shaped tongue 643 of second portion 644.

In some embodiments, a first portion 622 has a peg-shaped tongue 623 that may be coupled to a corresponding peg-shaped groove in second portion 624, as described. In some embodiments, a first portion 646 has a peg-shaped groove that may be coupled to a corresponding peg-shaped tongue 645 of second portion 648.

In some embodiments, the tongues and grooves described above are continuous along a length of a respective mirror portion. In some embodiments, the tongues and grooves described above are intermittent. In some embodiments, a plurality of tongue and groove types may be used in a particular mirror application. In some embodiments, a post and hole interlock may be used in a particular mirror application.

In some embodiments, joint types that may be used include one or more of: a biscuit joint, a bridle joint, a butt joint, a butterfly joint, a dowel joint, a coping joint, a cope and stick joint, a dado joint, a dougong joint, a dovetail joint, a finger joint, a halving joint, a cross-lap joint, a, halved joint, a dovetail-lap joint, an end-lap joint, a middle-lap (tee halving joint), a miter joint, a mortise and tendon joint, a pocket-hole joint, a rabbet (rebate) joint, a scarf (scarph) joint, a splice joint, a tongue and groove joint, and/or a frame and panel (rail and stile) joint.

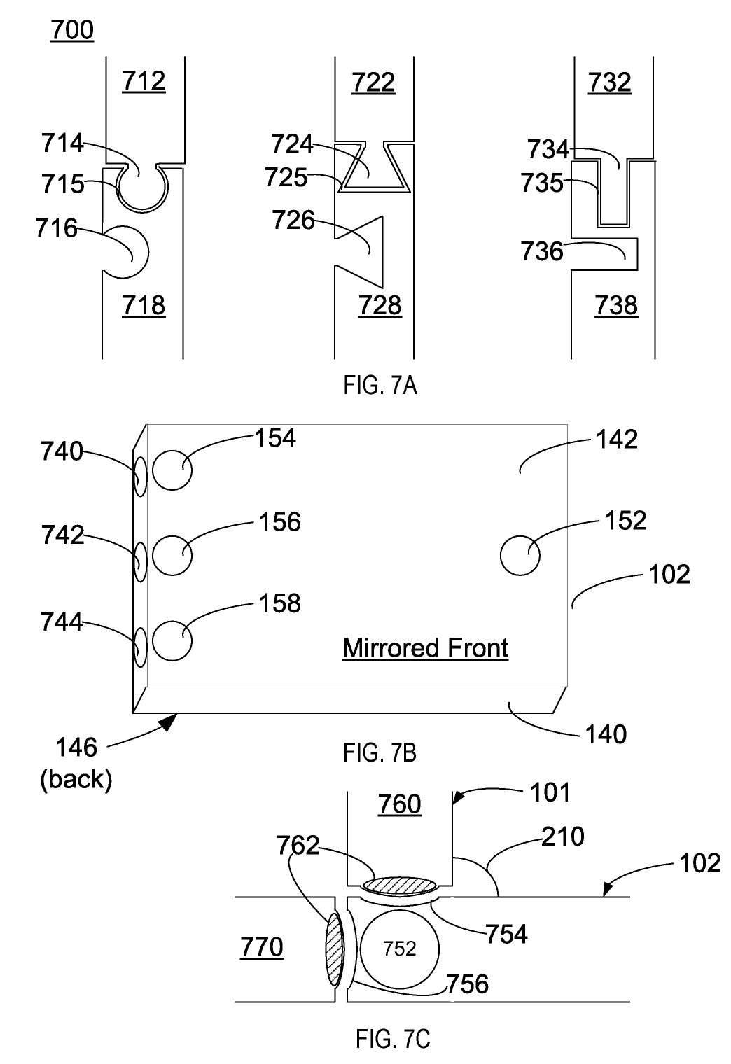

FIGS. 7A-7C illustrates a plurality of interlocking mechanisms for coupling first and second parts of a mirror together, with options to form both a non-reversing and a reversing mirror, according to some embodiments. Any of the described joint-types may be used alone or in combination.

FIG. 7A illustrates a plurality of mechanical interlock mechanisms. In some embodiments, a first portion 712 has a ball-shaped tongue 714. A second portion 718 has a first ball shaped groove 715 on a side edge, such that when the ball-shaped tongue 714 is inserted, the first portion and second portion form a reversing mirror, and in some embodiments, form a flat planar mirror. The second portion 718 also has a second ball shaped groove 716 on a front surface, such that when the ball-shaped tongue 714 is inserted, the first portion and second portion form an unreversing mirror at a substantially perpendicular angle.

In some embodiments, a first portion 722 has a dovetail-shaped tongue 724, with corresponding dovetail-shaped grooves 725 and 726 on a second portion 728, for positioning the mirrors in a flat or perpendicular arrangement, respectively. In some embodiments, a first portion 732 has a peg-shaped tongue 734, with corresponding peg-shaped grooves 735 and 736 on a second portion 738, for positioning the mirrors in a flat or perpendicular arrangement, respectively. In some embodiments, any type of tongue and groove or peg and hole arrangement could be used to position the first and second mirror portions.

FIG. 7B illustrates a plurality of magnetic interlock mechanisms. In some embodiments, a mirror portion 102 (e.g., corresponding to the second portions 718, 728, 738) has a first set of magnetic material (e.g., magnets, or material attracted by magnets) 740, 742, 744 on a side edge of the mirror. The mirror portion also has a second set of magnetic material 154, 156, 158 on a front surface 142 of the mirror. In some embodiments, a side edge 114 of a mirror portion 101 comprises one or more pieces of magnetic material 124, 126, 128, (FIG. 1) which may be coupled to either magnetic material 744, 742 and 740 (in a flat configuration) or to 158, 156, 153 (in a perpendicular configuration). In some embodiments, the flat configuration or the perpendicular configuration could be reversed, i.e., where the reflective surfaces face away from each other, with an angle between them of approximately 270 degrees.

FIG. 7C illustrates an embodiment where a magnet 752 embedded in the mirror 102 may provide a magnetic interlock for both a perpendicular orientation 760 (when magnetically coupled at point 754, angle 210 is approximately equal to 90 degrees) and a parallel orientation 770 (when coupled at point 756, angle 210 is approximately equal to 180 degrees). Mirror 101 has a magnet 762 embedded in an end 114. This magnet 762 may be coupled to magnet 752 in a parallel orientation, as described. In some embodiments, one or more of magnet 762 and 752 are rare earth magnets. In some embodiments, a magnetic attraction between 762 and 752 is sufficiently strong to securely hold the first mirror portion 101 and second mirror portion 102 together when the mirror is held by a user.

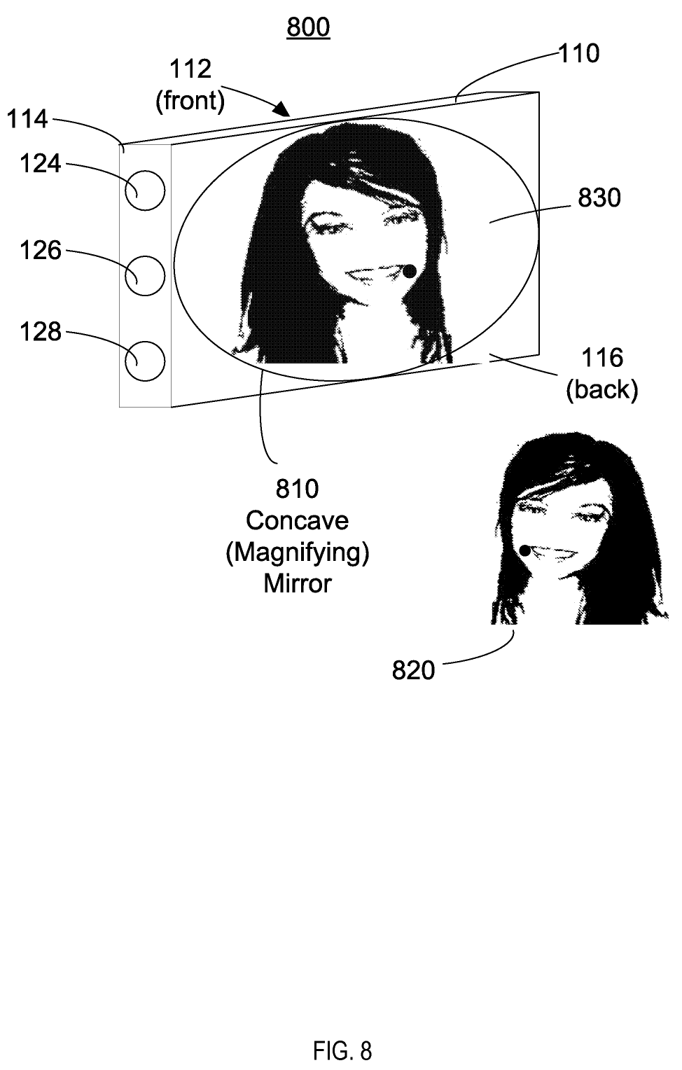

FIG. 8 illustrates a concave reversing mirror coupled to a back of a multi-part mirror, according to some embodiments. A concave (magnifying) mirror 810 is coupled to or formed in one of the first or second mirror portions. A concave mirror, or converging mirror, has a reflecting surface that bulges inward (away from the incident light). Concave mirrors reflect light inward to one focal point, therefore they are used to focus light. Unlike convex mirrors, concave mirrors show different types of image depending on the distance between the object and the mirror itself. These mirrors are called “converging” because they tend to collect light that falls on them, refocusing parallel incoming rays toward a focus. This is because the light is reflected at different angles, since the normal to the surface differs with each spot on the mirror.

A user 820 (with a beauty mark on the right hand side of her face) looks in the concave mirror 810. Her image 830 is shown as magnified (larger) and reversed, as the beauty mark appears on the opposite side of her face in the image 110. This concave mirror is useful for providing an up-close view when applying makeup, e.g., around the eye area.

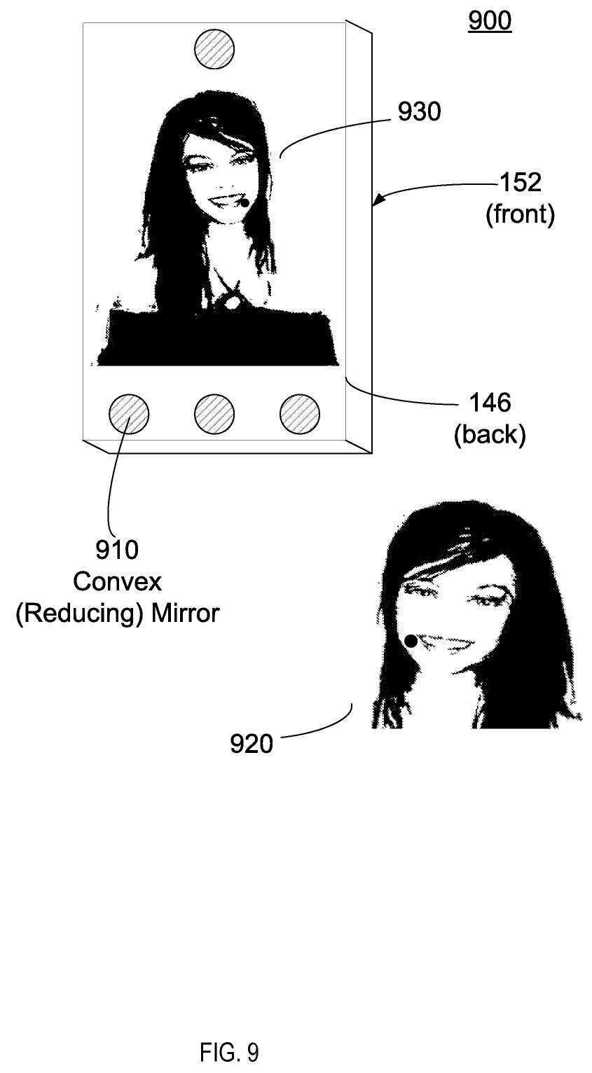

FIG. 9 illustrates a convex reversing mirror 910 coupled to a back of a multi-part mirror, according to some embodiments. A convex mirror (also known as a fish eye mirror or diverging mirror) is a curved mirror in which the reflective surface bulges toward the light source. Convex mirrors reflect light outwards, therefore they are not used to focus light. Such mirrors always form a virtual image. A collimated (parallel) beam of light diverges (spreads out) after reflection from a convex mirror, since the normal to the surface differs with each spot on the mirror. The image is always virtual (rays haven't actually passed though the image), diminished (smaller), and upright. These features make convex mirrors very useful: everything appears smaller in the mirror, so they cover a wider field of view than a normal plane mirror does as the image is “compressed”.

A user 920 (with a beauty mark on the right hand side of her face) looks in the convex mirror 910. Her image 930 is shown as reduced (smaller, showing not just the face but also the upper body) and reversed, as the beauty mark appears on the opposite side of her face in the image 930. This convex mirror is useful for providing a distant view e.g., to check out a user's ‘look’ including upper body, face, hair, etc. In some embodiments, the convex mirror may be shaped such that it is convex (curved) along a long axis only. In some embodiments, the convex mirror may be shaped such that it is more convex (curved) along a long axis than along a short axis. These features are useful in that the user may want to see a taller view (head and upper body) but not a wider view (she may not want to look distorted horizontally).

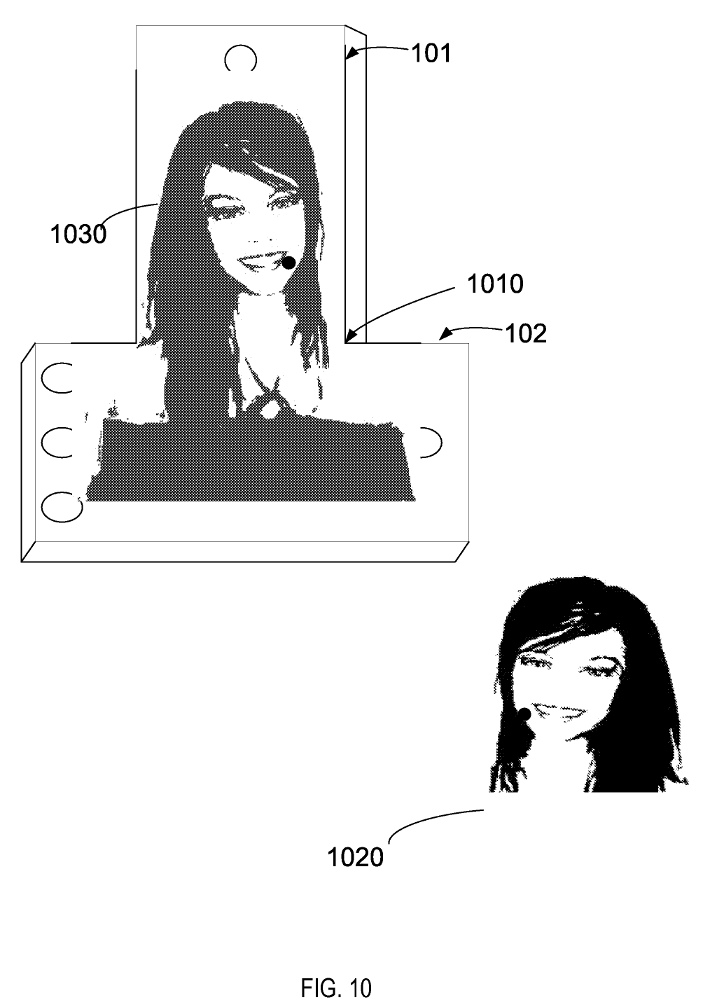

FIG. 10 illustrates first 101 and second 102 mirror parts coupled together in T-shaped configuration. This T-shaped configuration allows a user to get a ‘head and shoulder’ view of her face and upper body. In some embodiments, the first and second mirror parts are coupled at an edge 114 of the first part and 1010 of the second part. In some embodiments, the coupling is a magnetic coupling, as described. ISE the coupling is a mechanical interconnect, as described.

A user 1020 (with a beauty mark on the right hand side of her face) looks in the T-shaped mirror. Her image is shown as same size (unmagnified) with her face and upper body showing, and reversed, as the beauty mark appears on the opposite side of her face in the image 1030. This T-shaped mirror configuration is useful for providing an more complete view of her ‘look’ or appearance.

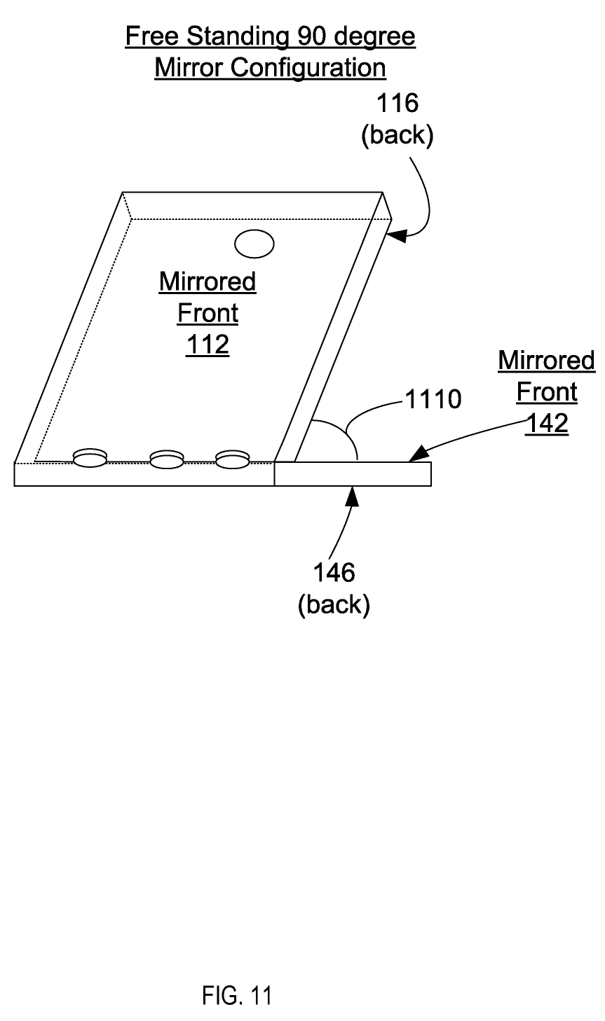

FIG. 11 illustrates a free standing configuration of the first 101 and second 102 mirror portions. In this configuration, the reflective surfaces (mirrored front 112 of first portion 101, and mirrored front 142 of second portion 102) face away from each other, with an angle between them of approximately 270 degrees. This free standing configuration is useful where a user may want to place the mirror (sitting on back surface 146) on a table or shelf and use it as a normal reversing mirror, while freeing up both hands.

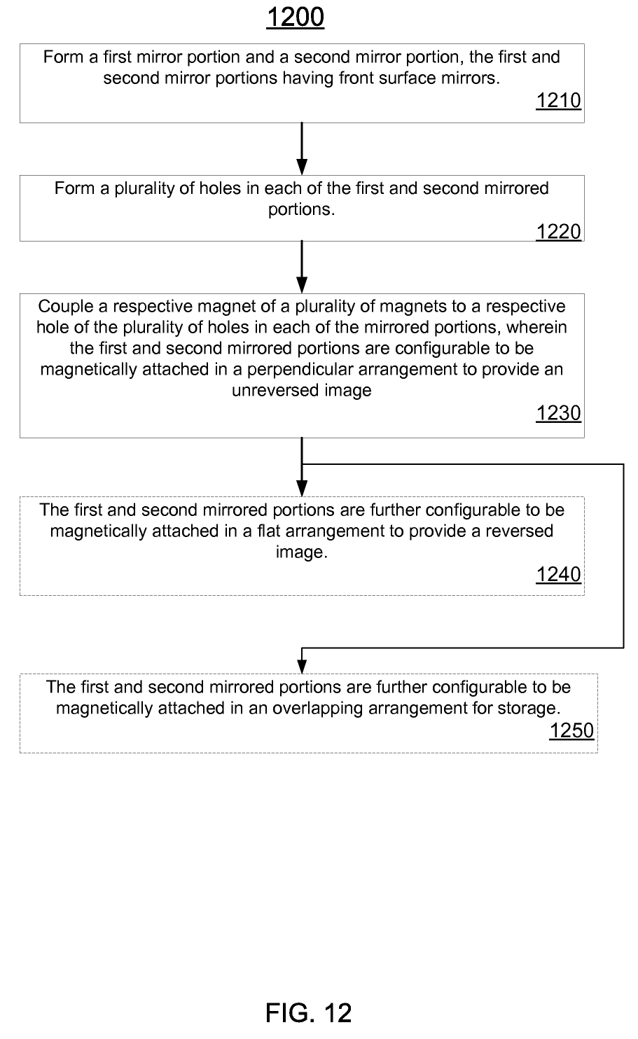

FIG. 12 illustrates a flow diagram of a method 1200 of manufacturing a mirror configurable as an unreversing mirror. A first mirror portion and a second mirror portion are formed, the first and second mirror portions having front surface mirrors (1210). A plurality of holes are formed in each of the first and second mirrored portions. (1220). A respective magnet of a plurality of magnets is coupled to a respective hole of the plurality of holes in each of the mirrored portions (1230). The first and second mirrored portions are configurable to be magnetically attached in a perpendicular arrangement to provide an unreversed image.

In some embodiments, the first and second mirrored portions are further configurable to be magnetically attached in a flat arrangement to provide a reversed image (1240). In some embodiments, the first and second mirrored portions are further configurable to be magnetically attached in an overlapping arrangement for storage (1250).

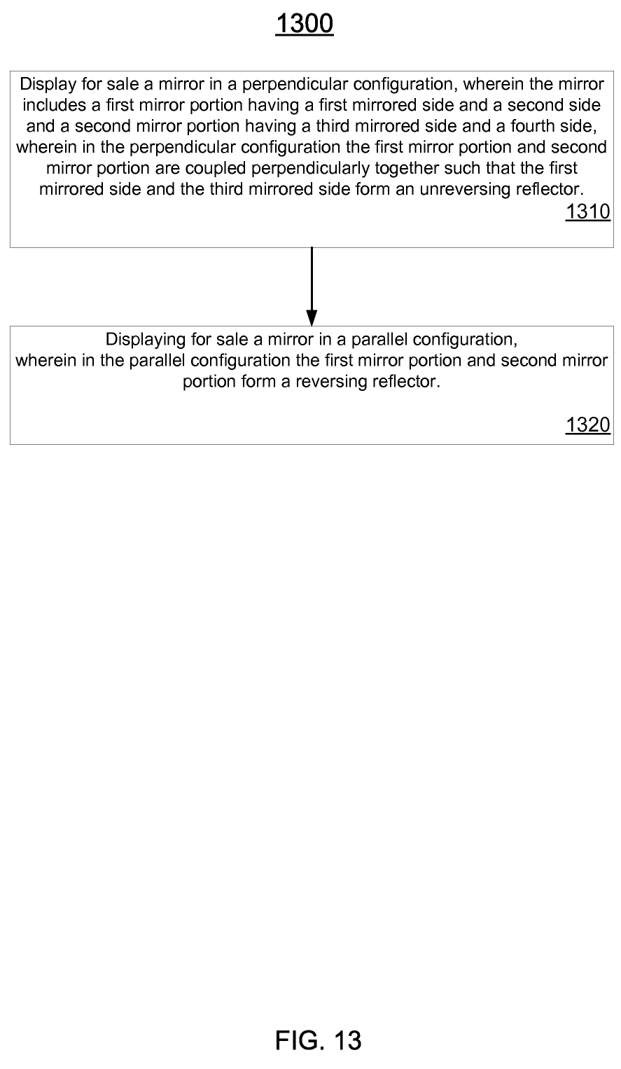

FIG. 13 illustrates a flow diagram of a method 1300 of displaying for sale a mirror configurable as an unreversing mirror.

A mirror is displayed for sale in a perpendicular configuration (1310). The mirror includes a first mirror portion having a first mirrored side and a second side and a second mirror portion having a third mirrored side and a fourth side. In the perpendicular configuration the first mirror portion and second mirror portion are coupled perpendicularly together such that the first mirrored side and the third mirrored side form an unreversing reflector. A mirror (e.g., similar to the mirror in the perpendicular configuration) is displayed for sale a mirror in a parallel configuration (1320), wherein in the parallel configuration the first mirror portion and second mirror portion form a reversing reflector.

In some embodiments, the mirror is displayed for sale as a video. In some embodiments, the mirror is displayed for sale as an image. In some embodiments, the mirror is displayed for sale as a pamphlet. In some embodiments, the mirror is displayed for sale as printed matter.

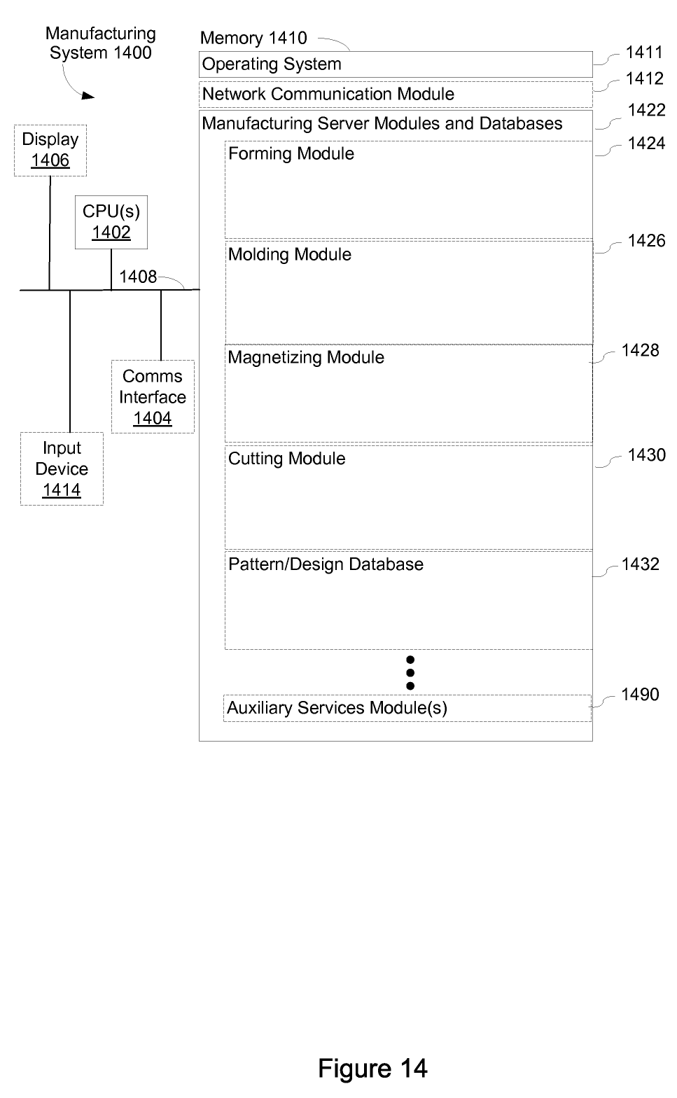

FIG. 14 is a diagram of a manufacturing system 1400. The system 1400 generally includes one or more processing units (CPU's) 1402, and optionally one or more network or other communications interfaces 1403, memory 1410, and one or more communication buses 1408 for interconnecting these components. The communication buses 1408 may include circuitry (sometimes called a chipset) that interconnects and controls communications between system components. The system 1400 may optionally include a user interface, for instance a display 1406 and a keyboard or other input device 1414.

Memory 1410 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1410 may optionally include one or more storage devices remotely located from the CPU(s) 1402. Memory 1410, or alternately the non-volatile memory device(s) within memory 1410, comprises a computer readable storage medium. In some embodiments, memory 1410 stores the following programs, modules and data structures, or a subset thereof:
an operating system 1411 that includes procedures for handling various basic system services and for performing hardware dependent tasks;
optionally, a network communication module 1412 that is used for connecting the manufacturing system 1400 to other computers via the one or more communication network interfaces 310 (wired or wireless) and one or more communication networks, such as the Internet, other wide area networks, local area networks, metropolitan area networks, an intranet, and so on;
a manufacturing system module and databases 1422, for storing instructions and/or designs or patterns for manufacturing a mirror configurable as an unreversing mirror, as described.;
a forming module 1424 having instructions for forming a mirror and parts and features thereof;
a molding module 1426 having instructions for molding a mirror and parts and features thereof;
a magnetizing module 1428 having instructions for applying magnets to the mirror and/or forming magnets within the mirror and/or magnetizing the mirror;
a cutting module 1430 having instructions for cutting a mirror and/or mirror portions from prefabricated mirror material, including front surface mirror material;
a pattern/design database 1430 having designs, patterns, templates and/or standard designs for mirrors, mirror portions and/or other reflective items; and
an auxiliary services module 1490 for providing support services, administrative services, maintenance services etc. for the manufacturing system 1400.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 1410 may store a subset of the modules and data structures identified above. Furthermore, memory 1410 may store additional modules and data structures not described above.

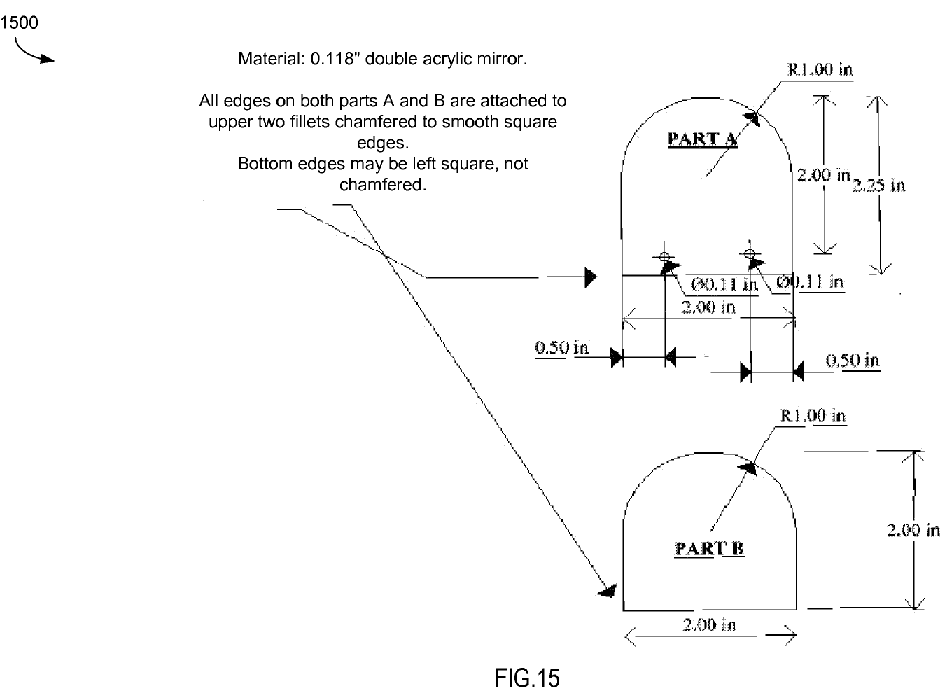

FIG. 15 illustrates an exemplary two-part mirror 1500 constructed from double acrylic.

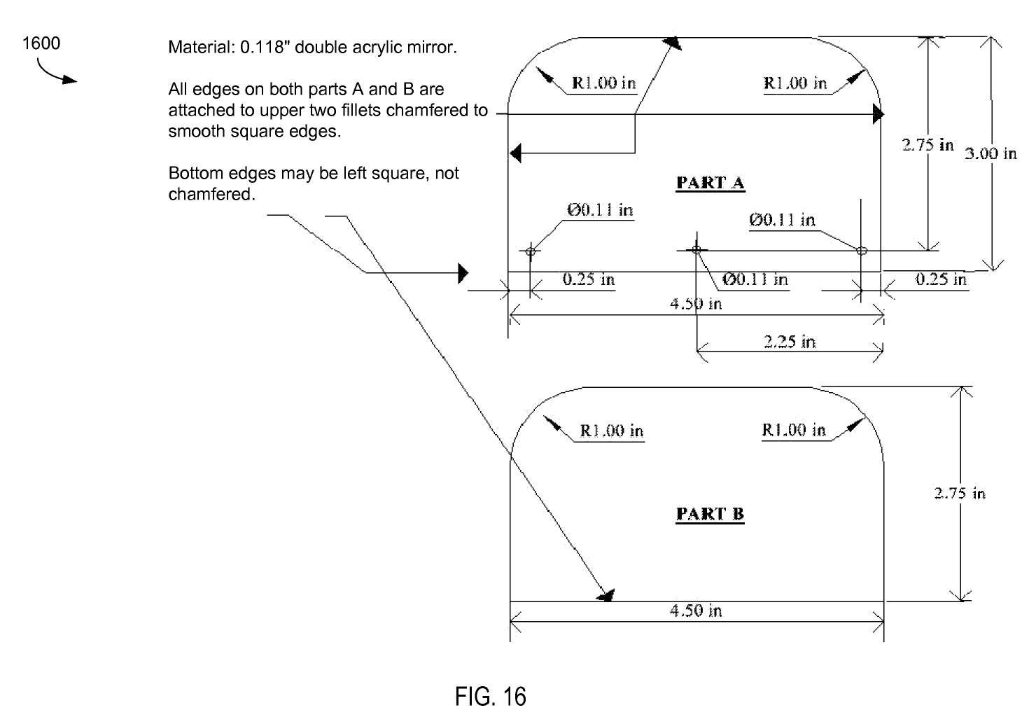

FIG. 16 illustrates an exemplary two-part mirror 1600 constructed from double acrylic.

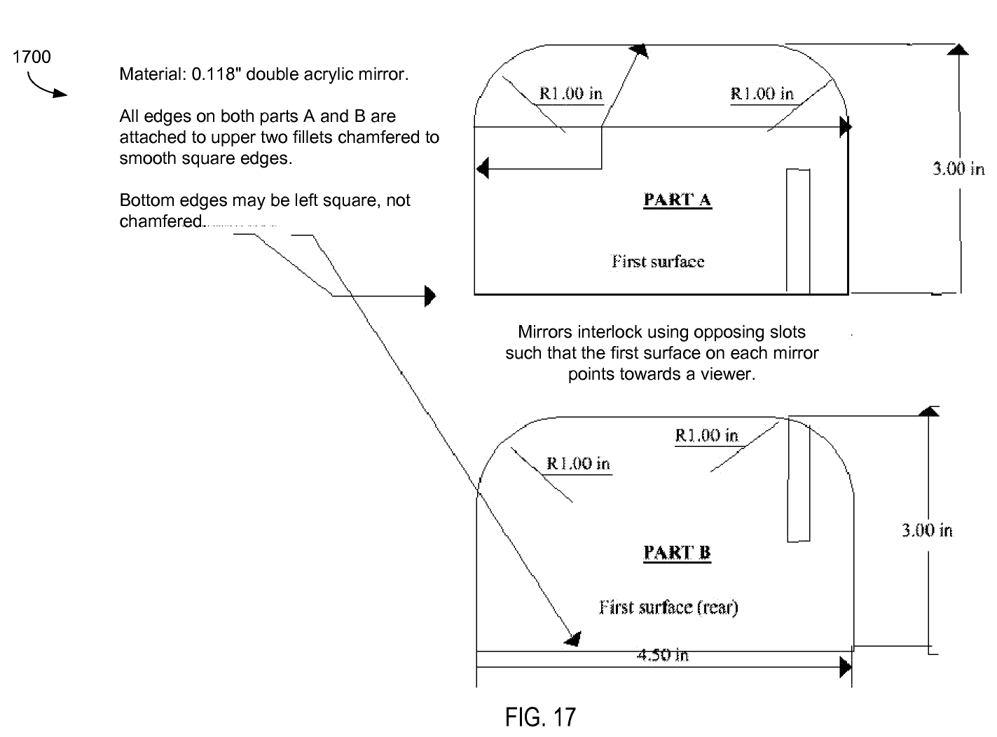

FIG. 17 illustrates an exemplary two-part mirror 1700 constructed from double acrylic, having interlocking slots.

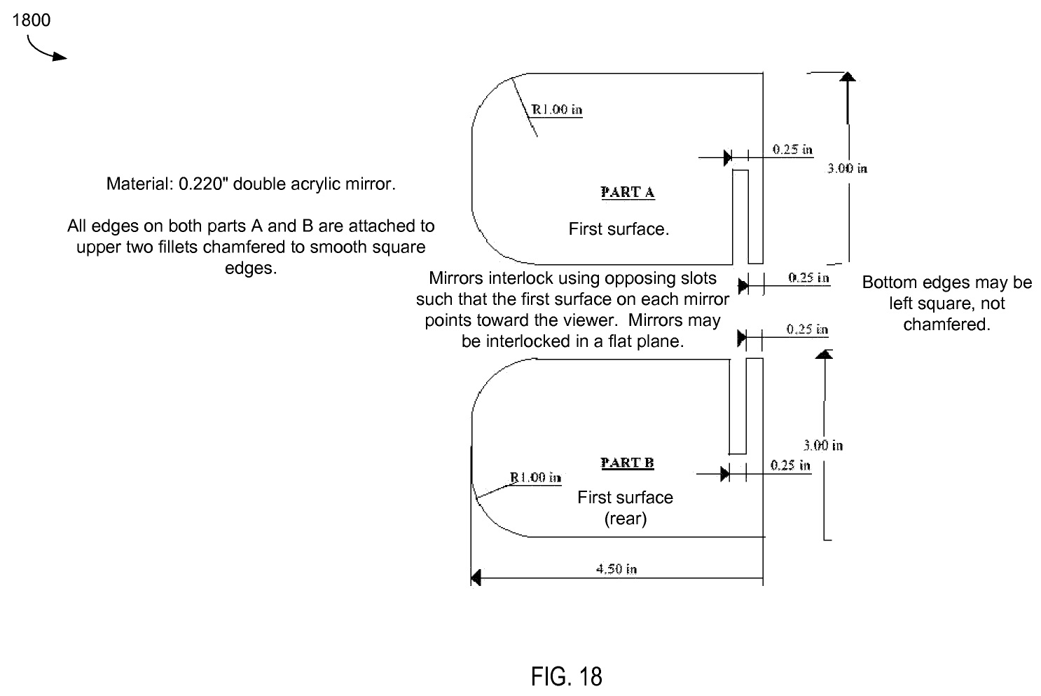

FIG. 18 illustrates an exemplary two-part mirror 1800 constructed from double acrylic, having interlocking slots.

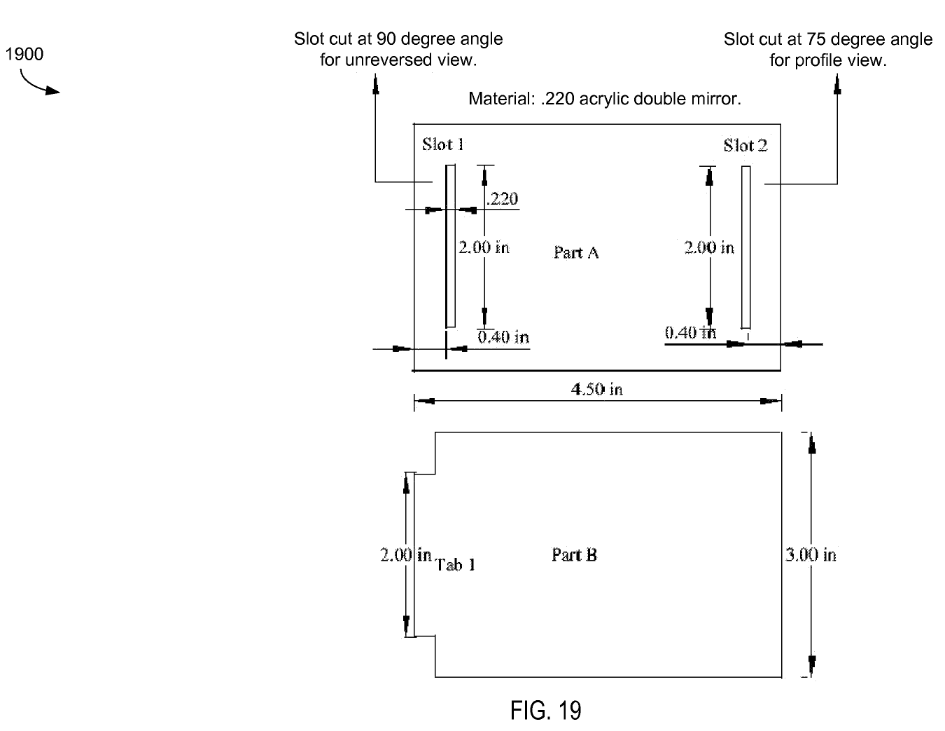

FIG. 19 illustrates an exemplary two-part mirror 1900 constructed from double acrylic, having mounting slots at a plurality of angles

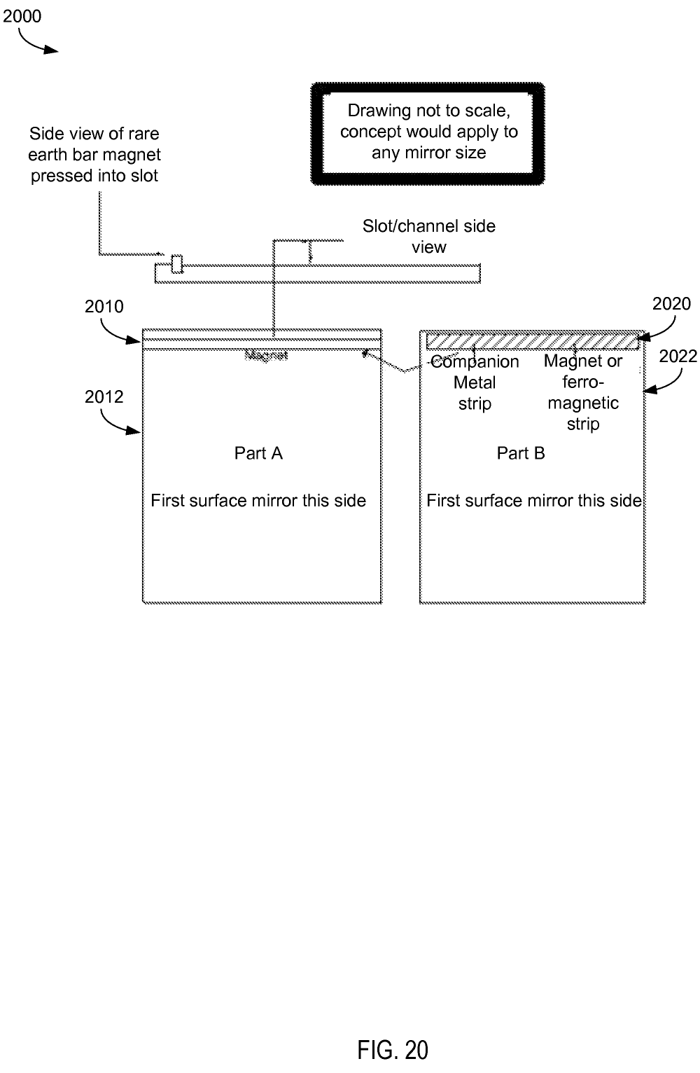

FIG. 20 illustrates an exemplary two-part mirror 2000 constructed from double acrylic, having mounting a bar magnet and a magnetic strip. A magnet 2010 in a rectangular or bar configuration is coupled (e.g., glued or press fit) to a first mirror portion 2012. A corresponding magnet and/or a magnetic material attracted to a magnet 2020 is coupled to a second mirror portion 2022. When the first mirror portion and second mirror portion are positioned together in a 90 degree angle, the magnet 2010 and magnetic material 2020 attract and keep the portions at the 90 degree angle. In some embodiments, the angle at which the mirrors are to be coupled could be any angle, including 70 degrees, 180 degrees, etc.

In some embodiments of the mirrors illustrated in FIGS. 15-20 are formed from double acrylic. In some embodiments the mirrors illustrated in FIGS. 15-20 are formed from other materials, including but not limited to plastic, glass, metal, ceramic, polymer, organic materials, etc.

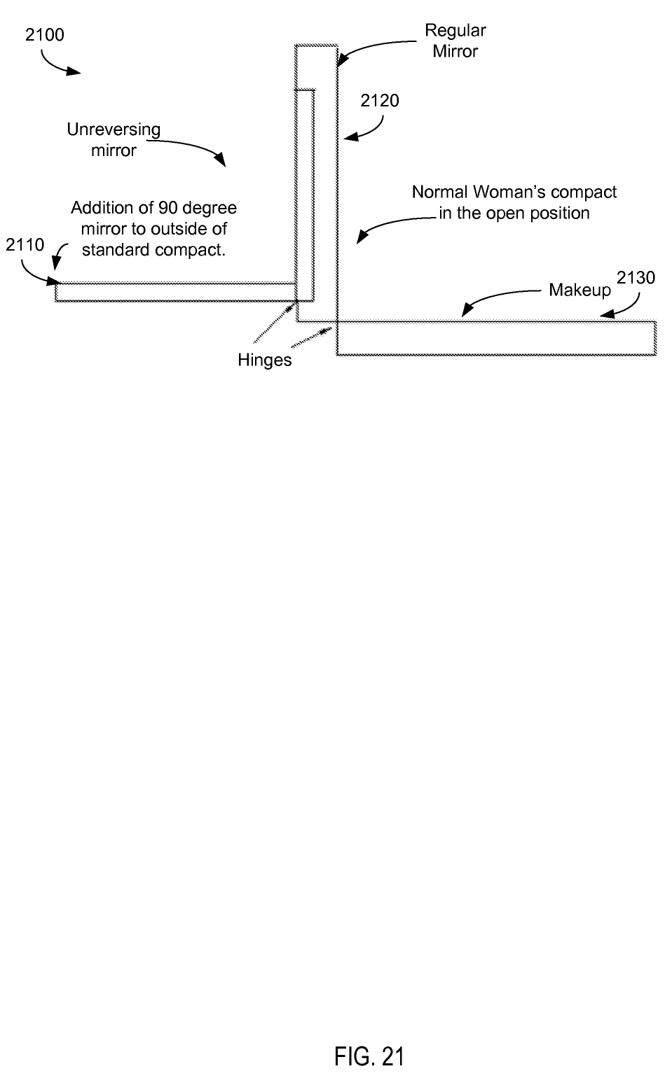

FIG. 21 illustrates an exemplary compact mirror 2100 having a normal mirror 2120 on an interior side and a hinged non-reversing mirror 2110 on an exterior surface. A portion 2130 serves as a makeup tray, as in a regular woman's makeup compact. The portion 2110 may be hinged in an outward direction to the regular mirror portion 2120. The regular mirror portion 2120 may be hinged to the makeup tray 2130.

In some embodiments, the portable mirror described herein comprises a first mirror portion and a second mirror portion, which when attached in a parallel arrangement, are configured to fit in a purse. In some embodiments, the portable mirror is can include any of the following size ranges, or any size between these ranges, including 8″×10″, 6″×4″, 5″×3″, 4×2″, 3″×1.25″, or smaller. In some embodiments, the portable mirror may be sized similarly to a makeup compact case, suitable for carrying in a purse or handbag.

In some embodiments, the portable mirror may be configured to be attached to a purse or a compact. In some embodiments, the portable mirror may be configured as part of purse or a compact. In some embodiments, the portable mirror may be configured as part of a luggage case, laptop case, or briefcase. In some embodiments, the portable mirror may be configured to be mounted on a stand. In some embodiments, the portable mirror may be configured with an angled side, such that when the mirror is placed on a flat surface (e.g., a tabletop, desk, vanity area, etc.) the portable mirror presents an unreflecting mirror at an angle to the flat surface.

In some embodiments, the portable mirror may have an attachment mechanism to prevent the mirror portions from being separated by more than a predefined distance. For example, a lanyard or bungee may be coupled to each of the mirror portions, allowing the mirror portions freedom of movement to be manipulated and configured in various ways, as described, but preventing the mirror portions from becoming separated from each other and lost. In some embodiments, the mirror portions may be of any shape, size or configuration. In some embodiments, the mirror portions may be tinted or have optical coatings (e.g., an anti-glare coating, color filter, etc.) providing a desired optical effect.

In some embodiments, the portable mirror may be configured to have an approximately 75 degree angle between the mirror portions. The approximately 75 degree angle may provide a side view of each side of a face, where the side views are located away from a point where the mirrors join. In some embodiments, the portable mirror may be configured to have an angle of between 65 degrees and 85 degrees between the mirror portions.

In some embodiments, the portable mirror may be formed as part of an electronic device, such as a cellular telephone, a multimedia player device, portable computer, etc. In some embodiments, the mirror surface may operate as a display and/or a touch-sensitive input for the electronic device, e.g., a touch sensitive screen having a mirrored finish. In some embodiments, a first portion of the mirror may function as a display portion of an electronic device (e.g., a screen), and a second portion of the mirror may function as an input portion (e.g., a touch sensitive input, as described) of the electronic device.

In some embodiments, a magnetic mirror assembly may be configured for use in dental surgery, hygiene, cleaning, cosmetic procedures, etc. For example, a magnetic mirror assembly may be sized such that it is suitable for insertion into a patient's mouth, e.g., a mirror of approximately 1 inch square, or any other size suitable for dental applications. The magnetic mirror assembly may be configurable to provide a variety of angles, according to needs of a dentist or hygienist. The magnetic mirror assembly may be configurable to provide an unreversed view of the mouth or portions thereof.

In some embodiments, the portable mirror portions may be configured for medical or clinical use, such as for self-examination of body parts for growths or abnormalities, discolorations, etc.

In some embodiments, the portable mirror portions may be configured for use in treating patients having dyslexia or other visual learning challenges.

In some embodiments, the portable mirror portions may be configured (e.g., using magnets or mechanical attachment mechanisms, as described) to stack. Thus, a plurality of portable mirrors (each having a plurality of mirror portions) may be assembled vertically or horizontally to make the image larger than if just a single portable mirror were used.

In some embodiments, the portable unreversing mirror may be attached to a handle and/or a shaft (fixed or flexible) and configured for inspecting objects, machinery, buildings, HVAC equipment, vehicles, aircraft, boats, electronics, etc. An unreversing mirror is very useful for reading serial numbers, labels, etc. from hard to reach areas. A conventional mirror would reverse text and characters, making them hard to read. An unreversing mirror would solve this problem by providing an unreversed (regular) view of the text and characters, making it easier to read and potentially avoiding mistakes due to misreading reversed characters or numbers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A portable mirror apparatus, comprising:
a first mirror portion having a first mirrored side and a second side; and
a second mirror portion having a third mirrored side and a fourth side, configured to be coupled perpendicularly by an attachment mechanism to the first mirror portion; such that
wherein the first mirror portion and second mirror portion, when attached in the perpendicular arrangement, are configured to provide an unreversed image.

2. The portable mirror apparatus of claim 1, wherein the first mirrored side and the third mirrored side face each other.

3. The portable mirror apparatus of claim 1, wherein the apparatus is configured for one-handed use when applying makeup.

4. The portable mirror apparatus of claim 1, wherein the first mirror portion and second mirror portion each comprise an attachment mechanism, and wherein the first mirror portion and second mirror portion are configurable to be attached in the perpendicular arrangement using the attachment mechanism.

5. The portable mirror apparatus of claim 1, wherein the attachment mechanism comprises a first magnet coupled to the first mirror portion and a magnetic metal coupled to the second mirror portion.

6. The portable mirror apparatus of claim 1, wherein the attachment mechanism comprises a first magnet coupled to the first mirror portion and a second magnet having a polarity opposite to the first magnet coupled to the second mirror portion.

7. The portable mirror apparatus of claim 1, wherein the attachment mechanism comprises a tongue on the first mirror portion and a groove on the second mirror portion, wherein the tongue and groove are configurable to hold the first and second mirrors in a perpendicular arrangement.

8. The portable mirror apparatus of claim 1, wherein the attachment mechanism comprises an insert on the first mirror portion and a hole on the second portion, wherein the insert and hole are configurable to hold the first and second mirrors in a perpendicular arrangement.

9. The portable mirror apparatus of claim 1, further comprising a latch mechanism coupled to the first mirror portion, wherein the latch mechanism is configurable to hold the first mirror portion and the second mirror portion together in a parallel overlapping arrangement.

10. The portable mirror apparatus of claim 9, wherein the latch mechanism comprises a first latch magnet coupled to the first mirror portion, and a latch magnetic metal coupled to the second mirror portion.

11. The portable mirror apparatus of claim 9, wherein the latch mechanism comprises a first latch magnet coupled to the first mirror portion, and a second latch magnet having a polarity opposite to the first latch magnet coupled to the second mirror portion.

12. The portable mirror apparatus of claim 1, further comprising a magnifying mirror coupled to the second side of the first mirror portion.

13. The portable mirror apparatus of claim 1, further comprising a reducing mirror coupled to the second side of the second mirror portion.

14. The portable mirror apparatus of claim 1, wherein the reducing mirror is shaped with a wider view along a long axis, and with a less wide view along a short axis.

15. The portable mirror apparatus of claim 1, wherein the first mirror portion and second mirror portion are further configured to be coupled with an angle between the mirrored surfaces greater than 90 degrees.

16. The portable mirror apparatus of claim 15, wherein the first mirrored side and the second mirrored side are in substantially the same plane, and are facing substantially the same direction.

17. The portable mirror apparatus of claim 15, wherein the first mirrored side and the second mirrored have an angle of greater than 180 degrees between them.

18. The portable mirror apparatus of claim 15, wherein the second attachment mechanism comprises a third magnet coupled to the first mirror portion and a magnetic metal coupled to the second mirror portion.

19. The portable mirror apparatus of claim 15, wherein the second attachment mechanism comprises a third magnet coupled to the first mirror portion and a fourth magnet having a polarity opposite to the third magnet coupled to the second mirror portion.

20. A portable magnetic mirror apparatus, comprising:
a first mirror portion having a first mirrored side and a second side; and
a second mirror portion having a third mirrored side and a fourth side, configured to be coupled perpendicularly via one or more magnets to the first mirror portion such that the first mirrored side and the third mirrored side provide an unreversed image.

21. The portable magnetic mirror apparatus of claim 20, wherein the first mirrored side and the third mirrored side face each other.

22. The portable magnetic mirror apparatus of claim 20, wherein the apparatus is configured for one-handed use when applying makeup.

23. The portable magnetic mirror apparatus of claim 20, wherein the first mirror portion and second mirror portion are further configurable to be attached in a planar reversing reflecting arrangement using the one or more magnets.

24. The portable magnetic mirror apparatus of claim 20, further comprising a first magnet coupled to the first mirror portion and a magnetic metal coupled to the second mirror portion.

25. The portable magnetic mirror apparatus of claim 20, further comprising a first magnet coupled to the first mirror portion and a second magnet having a polarity opposite to the first magnet coupled to the second mirror portion.

26. The portable magnetic mirror apparatus of claim 20, further comprising a latch mechanism coupled to the first mirror portion, wherein the latch mechanism is configurable to hold the first mirror portion and the second mirror portion together in a parallel overlapping arrangement.

27. The portable magnetic mirror apparatus of claim 26, wherein the latch mechanism comprises a first latch magnet coupled to the first mirror portion, and a latch magnetic metal coupled to the second mirror portion.

28. The portable magnetic mirror apparatus of claim 26, wherein the latch mechanism comprises a first latch magnet coupled to the first mirror portion, and a second latch magnet having a polarity opposite to the first latch magnet coupled to the second mirror portion.

29. A method of manufacturing a portable magnetic mirror apparatus, comprising:
forming a first mirror portion and a second mirror portion, the first and second mirror portions having front surface mirrors;
forming a plurality of holes in each of the first and second mirrored portions; and
coupling a respective magnet of a plurality of magnets to a respective hole of the plurality of holes in each of the mirrored portions, wherein
the first and second mirrored portions are configurable to be magnetically attached in a perpendicular arrangement to provide an unreversed image.

30. The method of claim 29, wherein the first and second mirrored portions are further configurable to be magnetically attached in a flat arrangement to provide a reversed image.

31. The method of claim 29, wherein the first and second mirrored portions are further configurable to be magnetically attached in an overlapping arrangement for storage.

32. A computer readable storage medium storing one or more programs configured for execution by a computer, the one or more programs comprising instructions to:
form a first mirror portion and a second mirror portion, the first and second mirror portions having front surface mirrors;
form a plurality of holes in each of the first and second mirrored portions; and
couple a respective magnet of a plurality of magnets to a respective hole of the plurality of holes in each of the mirrored portions, wherein
the first and second mirrored portions are configurable to be magnetically attached in a perpendicular arrangement to provide an unreversed image.

33. The computer readable storage medium of claim 32, wherein the first and second mirrored portions are further configurable to be magnetically attached in a flat arrangement to provide a reversed image.

34. The computer readable storage medium of claim 32, wherein the first and second mirrored portions are further configurable to be magnetically attached in an overlapping arrangement for storage.

35. A method of displaying a mirror for sale, comprising:
displaying for sale a mirror in a perpendicular configuration,
wherein the mirror includes a first mirror portion having a first mirrored side and a second side and a second mirror portion having a third mirrored side and a fourth side, and
wherein in the perpendicular configuration the first mirror portion and second mirror portion are coupled perpendicularly together such that the first mirrored side and the third mirrored side form an unreversing reflector; and
displaying for sale a mirror in a parallel configuration,
wherein in the parallel configuration the first mirror portion and second mirror portion form a reversing reflector.
